(19) United States
(12) Patent Application Publication
(10) Pub. No.: US 2025/0088380 A1
(43) Pub. Date: Mar. 13, 2025

(54) COMMUNICATION SYSTEMS AND METHODS

(71) Applicant: Apple Inc., Cupertino, CA (US)

(72) Inventor: Libo Cao Meyers, San Jose, CA (US)

(21) Appl. No.: 18/827,274

(22) Filed: Sep. 6, 2024

Related U.S. Application Data
(60) Provisional application No. 63/537,042, filed on Sep. 7, 2023.

(51) Int. Cl. H04L 12/18; G06F 3/0484

(52) U.S. Cl. CPC H04L 12/1822; G06F 3/0484

(57) ABSTRACT

Communication systems and methods are described herein. In some examples, a plurality of participants is detected in an area, and participant features of each of the plurality of participants are obtained. A plurality of participant tiles is generated. A group interface for a communication session is generated based on the plurality of tiles and rendered for display.

### CROSS-REFERENCE TO RELATED APPLICATIONS

The present application claims priority to U.S. Provisional Patent Application No. 63/537,042, entitled “Communication Systems and Methods” and filed on Sep. 7, 2023, which is incorporated by reference in its entirety herein.

### FIELD

Aspects of the present disclosure relate to communication systems and methods and more particularly to systems and methods for group conferencing with a plurality of participants disposed in an area.

### BACKGROUND

Communication systems may be used to conduct group conferences over a network. In some examples, a conference may include a plurality of participants disposed together in an area. Participants may be positioned at different locations in the area and in various orientations relative to a camera.

### SUMMARY

Implementations described and claimed herein provide systems and methods for group communications. In some implementations, a plurality of participants of a communication session is detected. The plurality of participants is collocated in an area. Participant features of each of the plurality of participants captured using at least one image sensor are obtained. A plurality of participant tiles is generated. Each of the participant tiles corresponds to the participant features of a corresponding one of the plurality of participants. A group interface for the communication session is generated based on the plurality of tiles. The group interface includes the participant features of each of the plurality of participants. The group interface is rendered for display using at least one display. Accordingly, each of the participants in the area can be clearly displayed to the recipient, even when one or more of the participants are occluded by structure(s) in the area.

In some implementations, a plurality of participants of a communication session is detected. The plurality of participants is collocated in an area. Participant features of each of the plurality of participants are extracted from image data of the area. A plurality of participant tiles is generated. Each of the participant tiles corresponds to the participant features of a corresponding one of the plurality of participants. A group interface for the communication session is generated based on the plurality of tiles. The group interface includes the participant features of each of the plurality of participants. The group interface for is output display during the communication session.

In some implementations, at least one image sensor is configured to capture image data of a plurality of participants of a communication session collocated in an area. At least one processor is configured to generate a group interface for the communication session based on a plurality of participant tiles. Each of the participant tiles is generated based on the image data and corresponds to participant features of a corresponding one of the plurality of participants. The group interface includes the participant features of each of the plurality of participants. A display is configured to display the group interface during the communication session.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows an example environment for group communication.

FIG. 2 illustrates generation of an example group interface.

FIG. 3 illustrates example operations for group communication.

FIG. 4 shows an example mobile device.

FIG. 5 shows an example computing system.

### DETAILED DESCRIPTION

Aspects of the presently disclosed technology relate to systems and methods to facilitate communication among a group. In some aspects, a communication session is initiated with a plurality of participants collocated in an area. Often, a camera shows a single view of the area. In many cases, it is challenging to clearly view each participant due to differences in positions, orientations, distances, obstructions, lighting conditions, and/or other variances among the participants and/or portions of the area. The camera may detect a particular participant speaking and modify the view to focus on the particular participant. While focusing on the particular participant, however, non-verbal communications (e.g., facial expressions, gestures, etc.) from other participants may be missed. Accordingly, one or more cameras capture image data of the area, and the faces of each participant are obtained from the image data. A plurality of tiles is generated, with each tile corresponding to one of the participant faces, and a group interface is generated based on the plurality of tiles, such that each participant's face is presented to one or more recipients involved in the communication session. In some instances, faces of each of the recipients, including any located outside of the area, are further presented in the group interface based on corresponding tiles.

The tiles may be homogenized in various manners to account for variances among the participants and/or corresponding areas in which each participant is located, thereby providing a consistent view of all participants in the group interface during the communication session. In some examples, each participant in an area is detected and in some instances an identification of each participant is determined. The identification of a participant may be used, for example, to homogenize the tiles with increased accuracy and/or to show portions of a participant face that are uncertain in the image data, for example that are occluded and/or have low visibility (e.g., due to lighting conditions, sensor quality, etc.). Accordingly, the presently disclosed technology facilitates communication among a group by providing a homogenized view of all participants throughout a duration of a communication session that accounts for and addresses variances in viewing quality among the participants and/or portions of the area(s) in which the participants are located.

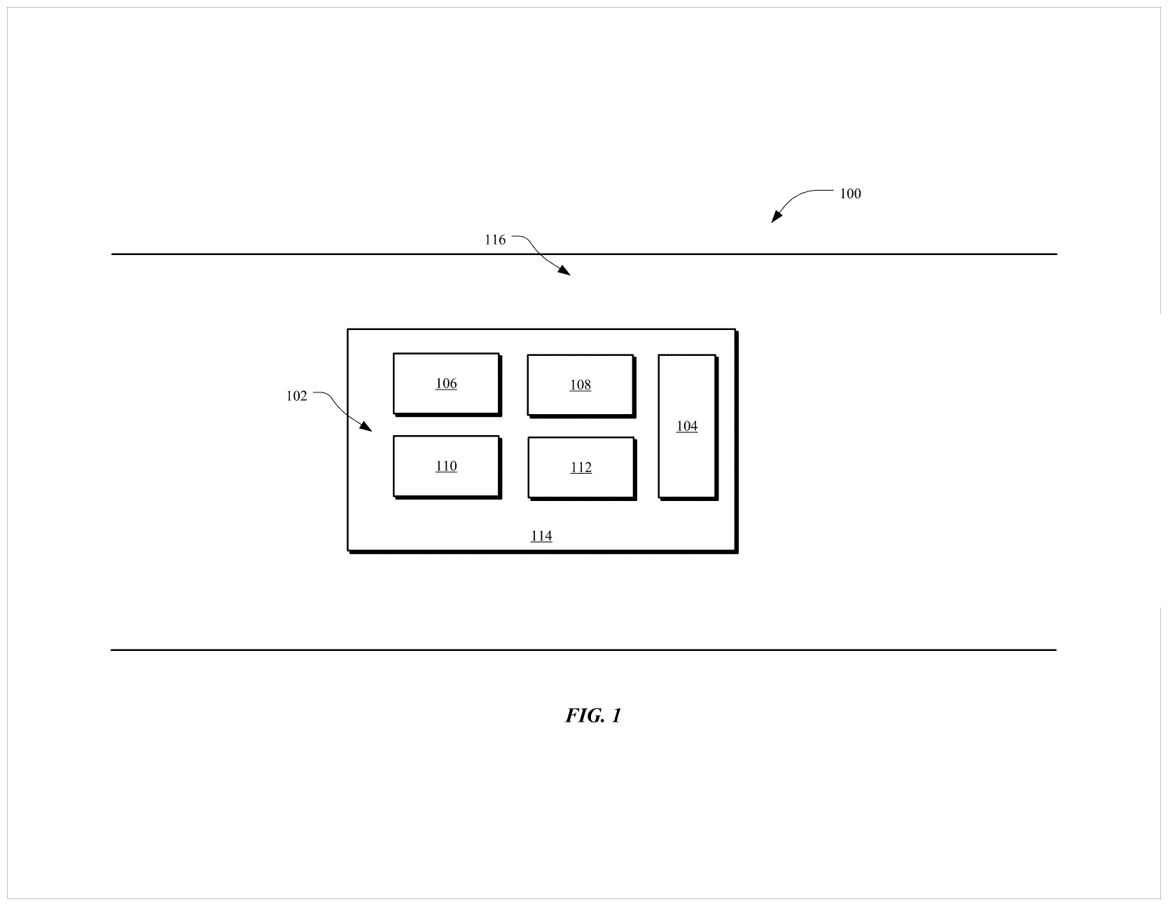

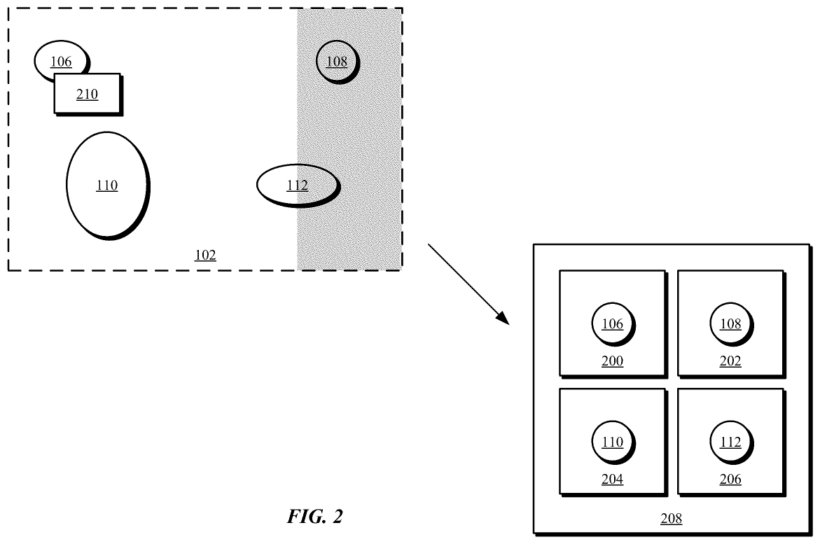

To begin a detailed description of an example environment 100 for group communication, reference is made to FIGS. 1-2. In some implementations, a sensor system 104 may be configured to capture image data of an area 102 (e.g., video), depth data, and other sensor data. The sensor system 104 has one or more fields of view of the area 102. The sensor system 104 may have one or more image sensors corresponding to the field(s) of view of the area 102. For example, the sensor system 104 may include a plurality of cameras disposed at various locations within the area 102 and having various fields of view of the area 102. In another example, the sensor system 104 includes a single camera. The single camera may include a plurality of lenses with a separate image sensor for each lens, thereby providing a plurality of fields of view of the area 102 using a single camera. For example, the sensor system 104 may include a stereo camera having a plurality of fields of view of the area 102. In examples where the sensor system 104 includes a plurality of image sensors, the image sensors may have overlapping fields of view of the area 102, distinct fields of view of the area 102, and/or combinations thereof. The sensor system 104 may include other sensors for capturing sensor data corresponding to the area 102 and/or one or more participants. In some examples, the sensor system 104 includes a camera corresponding to each of the participants, which be part of an integral device or separate devices.

A plurality of participants (e.g., a first participant 106, a second participant 108, a third participant 110, and a fourth participant 112) may be collocated in the area 102. In some implementations, the area 102 is in a structure 114, such that the participants 106-112 are collocated in the structure 114. For example, the area 102 may be within an interior of the structure 114. The structure 114 may be stationary, such that the structure 114 is fixed in place, or mobile, such that the structure 114 is configured to move along a movement path 116 from an origin towards a destination. For example, the structure 114 may be a mobile device transporting the participants 106-112 along the movement path 116, with the area 102 disposed within an interior of the mobile device. In some instances, one or more second participants may be located in a second area or move between the area 102 and other locations. The second area may be separate from the area 102, outside of the structure 114, remote from the structure 114, and/or outside the field(s) of view of sensor(s) in the sensor system 104.

A communication session may be initiated for the participants. For example, the participants 106-112 may be collocated in the area 102 and communicate with the one or more second participants via the communication session. The communication session may be initiated in various manners, such as using a displayed option, a voice command, a gesture command, a user command, and/or an identifier. Participants may be added to or join the communication session similarly. For example, the communication session may be initiated between a remote participant and the first participant 106. In accordance with user preferences and consent, the participants 108-112 may be detected within the area 102, and an option to add the participants 108-112 to the communication session may be presented. Upon approval, the participants 108-112 may be added to the communication session. If any of the participants 108-112 declines to join the communication session, sensor data corresponding to that participant may be excluded from the communication session. In some examples, the communication session is initiated between a group disposed in the area 102 and one or more second participants in one or more corresponding areas. In connection with initiation of the communication session, each of the participants in the group (e.g., the participants 106-112) may be detected in the area 102, with the second participants being similarly detected in the corresponding area(s). The participants may be detected using sensor data captured by the sensor system 104, user input, and/or other data corresponding to the participants and/or the areas.

In some implementations, the sensor system 104 captures participant features of each of the participants 106-112 in the area 102 in accordance with user consent. The participant features may include facial features of the participants 106-112. A participant tile is generated for each of the participants 106-112 based on the participant features. More particularly, a first participant tile 200 is generated based on the participant features corresponding to the first participant 106, a second participant tile 202 is generated based on the participant features corresponding to the second participant 108, a third participant tile 204 is generated based on the participant features corresponding to the third participant 110, and a fourth participant tile 206 is generated based on the participant features corresponding to the fourth participant 112. For example, each of the participant tiles 200-206 may include a face of the corresponding participant 106-1112. Based on the participant tiles 200-206, a group interface 208 is generated for the communication session. The group interface 208 may similarly be generated based on participant tiles corresponding to participants located in the second area(s). In one example, the group interface 208 is generated by stitching the participant tiles 200-206 together.

The group interface 208 is displayed to the area 102 and the second area(s). In some examples, the group interface 208 displayed to recipients in the second area corresponds to the participants in the area 102, and a different group interface displayed to the participants in the area 102 corresponds to the participants in the second area. In other examples, the group interface 208 corresponds to all participants independent of the area in which the participants are located.

Based on the participant tiles 200-206, the participants 106-112 may be displayed with the group interface 208 in an order. The order may include the participants 106-112 arranged on the group interface 208 based on corresponding positions within the area 102, which may change if the participants 106-112 move or change positions within the area 102. The order may be updated or otherwise determined based on a participation level of each of the participants 106-112 in the communication session. For example, the participant 112 may be present in the area 102 but not actively participating in the communication session and arranged on the group interface 208 relative to the participants 106-110 accordingly.

Despite any variances in viewing quality by the sensor system 104 among the participants 106-112 and/or portions of the area 102, the group interface 208 may provide a uniform presentation of each of the participant tiles 200-206, such that faces of each of the participants 106-112 are equally displayed concurrently. For example, as can be understood from FIG. 2, there may be differences in positions, orientations, distances, obstructions, lighting conditions, and/or other variances among the participants 106-112 and/or portions of the area 102. In the example shown in FIG. 2, the first participant 106 and the second participant 108 are disposed at a greater distance from the sensor system 104 than the third participant 110 and the fourth participant 112, such that the participants 106-108 appear smaller in size relative to the participants 110-112. Additionally, the participants 106-112 are facing different directions or otherwise oriented differently from each other, such that the participants 106-112 appear differently and/or portions of their faces are indiscernible. Similarly, the second participant 108 is in darker lighting conditions than the first participant 106 and the third participant 110, and the fourth participant 112 is partially in the darker lighting conditions. The first participant 106 is further partially obstructed from the field of view of the sensor system 104 by an object 210. To account for such variances, the participant tiles 200-206 may be homogenized.

In some examples, the participant tiles 200-206 may be homogenized through one or more optimization actions, such as tile optimization actions and/or feature optimization actions. The optimization actions may be applied within two-dimensions and/or three-dimensions, and the group interface 208 may be rendered for two-dimensional or three-dimensional display. The tile optimization actions may modify one or more of the participant tiles 200-206. For example, the tile optimization actions may include panning, zooming, tilting, straightening, rotating, cropping, and/or transforming the participant tiles 200-206. The tile optimization actions form the participant tiles 200-206 with a uniform size, shape, and orientation for arrangement in the group interface 208. Additionally, the participant features of the corresponding participants 106-112 are similarly positioned within the participant tiles 200-206 in relation to each other. For example, the participant features of the first participant 106 may be positioned at a center of the first participant tile 200 with a predetermined amount of space around the participant features within the first participant tile 200. Tile optimization actions may be applied to the participant tiles 202-206 to create the same positioning and spacing as the first participant tile 200 to provide a uniform appearance of sizing and spacing of the participants 106-112 in the group interface 208.

The tile optimization actions may further include applying one or more image adjustments to the participant tiles 200-206. For example, the image adjustments may include adjusting exposure, brilliance, highlights, shadows, contrast, brightness, black point, saturation, vibrance, warmth, tint, sharpness, definition, noise reduction, and/or vignette of the participant tiles 200-206. Similarly, background content may be removed from the area 102 in generating the group interface 208, such that content other than participant features is omitted from the participant tiles 200-206. Through image adjustments and content removal, the participant tiles 200-206 are further generated with a uniform appearance despite any variances in lighting conditions, sensor quality, and/or visibility for different the participants 106-112 within the area 102.

The feature optimization actions may modify the participant features corresponding to one or more of the participants 106-112 in generating the participant tiles 200-206. The sensor system 104 may capture depth data corresponding the participant features. The feature optimization action may be applied based on the depth data. For example, the feature optimization actions may include modifying a viewing angle of one or more of the participants 106-112, modifying an orientation of one or more of the participants 106-112, removing obstructions occluding participant features of one or more of the participants 106-112, and/or increasing visibility of one or more of the participants 106-112.

In removing obstructions, an occlusion of a portion of the participant features may be detected, and an unobstructed view of the corresponding participant may be generated using a heuristics action. For example, artificial intelligence and/or machine learning algorithms may be used to determine how the participant features of the corresponding participant appear in various participant conditions (e.g., orientations, positions, emotions, operations, etc.). An identity of the corresponding participant that is occluded and the participant conditions may be determined. Using the artificial intelligence and/or machine learning algorithms, a rendering of the portion of the participant features is generated and combined with the remaining participant features in generating the participant tile to provide an unobstructed view of the corresponding participant in the group interface 208. In doing so, an expression of the corresponding participant may be determined, with the rendering of the portion of the participant features matching the expression of the corresponding participant. Accordingly, if the portion of the participant features occluded is the mouth and the corresponding participant is frustrated, for example, the rendering of the portion includes a mouth with a matching frustrated expression as opposed to an expression associated with a different emotion (e.g., smiling). Any portions of the participant features with low visibility may be similarly detected and corrected through features optimization action(s) using a heuristics action for those participant features. Feature optimization actions are applied to the participant features in generating the participant tiles 202-206 as necessary to provide complete, high-quality views of the participants 106-112 in the group interface 208 from a uniform perspective and/or viewing angle.

In this manner, the participants 106-112 may be detected in the area 102, with corresponding participant features extracted from image data (e.g., video) of the area 102 that is captured using the sensor system 104. The participant features are separated to create individual participant tiles 200-206, each corresponding to a particular participant. The participant tiles 200-206 are homogenized and constructed together in the group interface 208 for uniform presentation of the participants 106-112 independent of varying participant conditions, area conditions, environmental conditions, and/or other differences among the participants 106-112 and/or the area 102.

Referring to the illustration in FIG. 2 as an example, tile optimization actions and/or feature optimization actions may be applied to the participant tile 200 to normalize the sizing differences of the first participant 106 relative to the other participants 108-112 based on the distances of each of the participants 106-112 from the sensor system 104 and/or the locations of the participants 106-112 within the area 102. Similar actions may be applied in generating the participants tiles 202-206 to provide uniform sizing of the participants 106-112 in the group interface 208 reflecting the realistic proportions of the participant faces in the real-world environment. The different viewing angles of the sensor system 104 relative to a front of each of the faces of the participants 106-112 and different orientations of participant features relative to the sensor system 104 may be further normalized through tile optimization actions and/or feature optimization actions in generating the participant tiles 200-206. In doing so, any indiscernible, obstructed, and/or low visibility portions of the participant features may be created using heuristic actions and/or other sensor data to generate the participant tiles 200-206 and thereby create the group interface 208 with unobstructed, high-quality views of the participants 106-112 from a uniform viewing angle. For example, the first participant tile 200 is generated such that the first participant 106 is shown with the object 210 removed, and effects of the different directions the participants 106-112 are facing and the different orientations of the participants 106-112 on the rendering of the participant features are addressed in generating the participant tiles 200-206. Finally, the different lighting conditions of the participants 106-112 in the area 102 are normalized to provide a unfirm image quality and presentation across the group interface 208. As such, as shown in FIG. 2, the group interface 208 includes the complete faces of the participants 106-112 with uniform size, viewing angle, image quality, and/or presentation that is consistent with the real-world appearances of the participants 106-112, independent of any variances in conditions among the participants 106-112 within the area 102. Further, in some examples, one or more of the participants 106-112 may move within the area 102, between the area 102 and the second area(s), and/or conditions may continue to change for the participants 106-112 and/or the area 102, such that variances due to changing conditions are addressed in real time through dynamic optimization actions to maintain the group interface 208 with uniform size, viewing angle, image quality, and/or presentation of the participants 106-112.

The group interface 208 may be further optimized for rendering in various manners. As previously described, background content from the area 102 may be removed from the participant tiles 200-206. Alternatively, sensor data corresponding to the background content may be discarded, such that the participant tiles 200-206 are generated without the background content. Background content may refer to any portions of the area 102 and/or participants other than the participant features. The participant features may correspond to a head of each of the participants 106-112, a body of each of the participants 106-112, and/or combinations or portions thereof. The group interface 208 may be generated and rendered such that a boundary between the participant tiles 200-206 is visible or invisible. For example, boxes may be shown around each of the participants 106-112 in the group interface 208 based on the participant tiles 200-206 or the participants 106-112 may be shown in the group interface 208 adjacent to each other without boxes or similar boundaries. The participants 106-112 may be arranged on the group interface 208 based on their location within the area 102, participation level in the communication session, and/or otherwise according to user preferences. The participants 106-112 may be rendered in two-dimensions or three-dimensions in the group interface 208, with the group interface 208 being presented using an interface system associated with the area 102 and/or the structure 114, a plurality of electronic devices, such as user devices associated with one or more of the participants 106-112 (e.g., wearables, smartphones, etc.), and/or a combination thereof.

The participant tiles 200-206 may be arranged in the group interface 208 to indicate to second participants (e.g., outside the area 102) how each of the participants 106-112 are positioned within the area 102. For example, as discussed herein, in some examples, the area 102 is located within an interior of the structure 114, which may be a mobile device (e.g., a vehicle). The first and second participants 106-108 may be located in back seats of the mobile device, and the third and fourth participants 110-112 may be located in front seats of the mobile device. The fourth participant 112 may be positioned in a driver seat. In some instances, the sensor system 104 may have a camera positioned at a front of the mobile device, such that the third and fourth participants 110-112 are closer to the camera than the first and second participants 106-108. For example, the camera may be fixed at a top center of a front window of the mobile device (e.g., near a rearview mirror). As such, the camera would capture the first and second participants 106-108 in a smaller size relative to the third and fourth participants 110-112. These variances are homogenized in generating the group interface 208, as described herein, to provide a normalized presentation of the participants 106-112. Moreover, rather than the participants 106-112 having to lean together to appear in a video together, each of the participants 106-112 may sit comfortably in the individual seats, with the participant features being of each of the participants 106-112 extracted from the video to form individual participant tiles 200-206 for homogenization and combination into the group interface 208. The participant tiles 200-206 may be arranged in the group interface 208 to indicate to second participants (e.g., participants outside of the mobile device) how each of the participants 106-112 are seated within the mobile device. For example, the group interface 208 may have the participants 106-112 displayed in an arrangement representing driver side and passenger side passengers. The optimization actions may be applied with respect to the participants 106-112 as appropriate, such that if one of the participants 106-112 turns to look at one of the other participants 106-112 or otherwise away from the camera, the viewing angle of the participants 106-112 remains consistent, with the participant turning not being reflected in the group interface 208 during the communication session.

Further, in connection with or separate from a communication session, the participant features of one of more of the participants 106-112 may be extracted and analyzed in connection with an attitude of the participants 106-112 towards an operation or characteristic of the mobile device. For example, the participant features may be compared with participant features representative of a readiness of the participants for a particular operation mode of the mobile device, a particular navigation action of the mobile device, a particular operational action of the mobile device, and/or autonomy operations. The operation mode of the mobile device may include an autonomous operation mode and a manual operation mode. In some examples, an operation mode transition trigger for the mobile device may be detected using the participant features, with the mobile device transitioning between the autonomous operation mode and the manual operation mode based on the operation mode transition trigger. The operation mode transition trigger may correspond to the readiness of the participants for the transition (e.g., a driver is alert for assuming manual control of the mobile device).

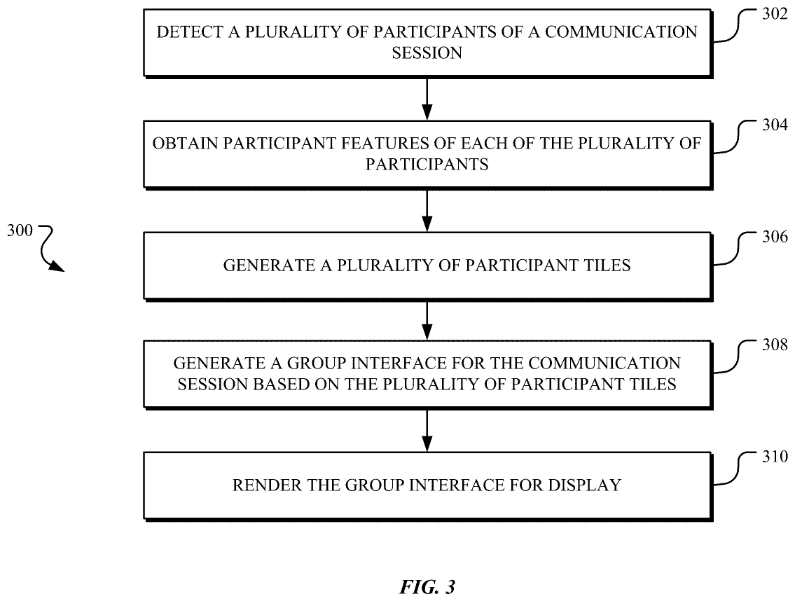

Turning to FIG. 3, example operations 300 for group communication are shown. An operation 302 detects a plurality of participants of a communication session. The plurality of participants may be collocated in an area and/or located in different areas. In some examples, the area is an interior of a vehicle.

An operation 304 obtains participant features of each of the plurality of participants. The participant features may be captured using at least one image sensor. The at least one image sensor may be configured to capture image data of the area, such as video. In some examples, the operation 304 extracts participant features of each of the plurality of participants from the image data of the area. The at least one image sensor may include a plurality of image sensors having overlapping fields of view of the area. The at least one image sensor and a display may be associated with a vehicle (e.g., positioned within the interior of the vehicle).

An operation 306 generates a plurality of participant tiles. Each of the participant tiles corresponds to the participant features of a corresponding one of the plurality of participants. The plurality of participant tiles may be homogenized to address effects of variances in conditions among the participants and/or the area(s) in which the participants are located. For example, homogenizing the participant tiles may include applying a tile optimization action to at least one participant tile of the plurality of participant tiles, applying a feature optimization action to the participant features of at least one participant tile of the plurality of participant tiles, and/or the like. The tile optimization action may modify the at least one participant tile within two-dimensions, and/or the feature optimization action may modify the participant features within three-dimensions. For example, the feature optimization action may modify a viewing angle of one or more of the plurality of participants.

Further, optimization actions, such as tile optimization actions applied to one or more of the participant tiles and/or feature optimization actions applied to participant features corresponding to one or more of the participant tiles, may address an effect of occlusions or reduced visibility of a portion of participant features of a specific participant. For example, an occlusion of a portion of the participant features of a specific participant of the plurality of participants may be detected, and an unobstructed view of the specific participant may be generated using a heuristics action. The unobstructed view includes a rendering of the portion of the participant features. In doing so, an expression of the specific participant may be determined, and a rendering of a portion of the participant features corresponding to the specific participant may be rendered with the rendering generated based on the expression. As such, the rendering of the portion of the participant features may be matched with the expression of the specific participant.

An operation 308 generates a group interface for the communication session based on the plurality of tiles. The group interface includes the participant features of each of the plurality of participants. In some examples, the group interface includes the participant features of each of the plurality of participants arranged according to a corresponding position of each of the plurality of participants within the area (e.g., the interior of a vehicle). Additionally, second participant features of each of one or more second participants located in a second area may be obtained, with the second area being outside of one or more fields of view of the at least one image sensor. One or more second participant tiles may be generated, and the group interface for the communication session is further generated based on the one or more second participant tiles.

An operation 310 renders the group interface for display during the communication session. The group interface may be displayed using at least one display. In some examples, the group interface removes and/or omits background content from the area. Further, the at least one image sensor may include a depth sensor, and the image data includes depth data of the participant features. In this example, the participant features may be rendered in three-dimensions in the group interface based on the depth data. In connection with or independent of the communication session, an operation mode transition trigger for a vehicle may be detected using the participant features. The vehicle may be transitioned between an autonomous operation mode and a manual operation mode based on the operation mode transition trigger.

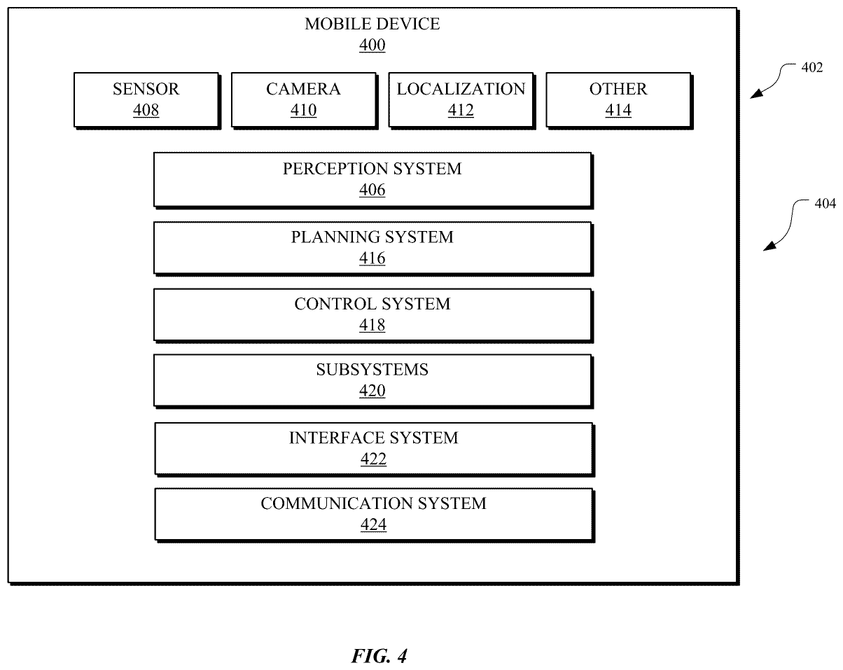

Turning to FIG. 4, an example mobile device 400, which may be the structure 114, is shown. In some implementations, the mobile device 400 includes one or more sensor systems 402 and device systems 404. It will be appreciated that any of a perception system 406, LIDAR sensors 408, cameras 410, localization systems 412, other sensors 414, a planning system 416, a control system 418, subsystems 420, an interface system 422, and/or a communication system 424 may be part of, separate from, or not included in the device systems 406. Further, the interface system 422 and the communication system 424 may be separate from and/or part of the subsystems 420.

The sensor system 402 includes one or more sensors configured to capture sensor data, including, but not limited to: data of a field of view of an interior (e.g., the area 102) and/or an exterior of the mobile device 400 (e.g., one or more images); localization data corresponding to a location, heading, and/or orientation of the mobile device 400 and/or participants; movement data corresponding to motion of the mobile device 400, the area 102, and/or the particpants (e.g., along the movement path 116); mobile device information, participant information (based on user preferences and consent), and/or data corresponding to a communication session. The one or more sensors of the sensor system 402 may include, without limitation, 3D sensors configured to capture 3D images, 4D sensors configured to capture 4D images, RADAR sensors, infrared (IR) sensors, optical sensors, and/or visual detection and ranging (ViDAR) sensors. For example, the one or more 3D sensors may include the LIDAR sensors 408 (e.g., scanning LIDAR sensors) or other depth sensors, and the one or more 4D sensors may include the cameras 410 (e.g., RGB cameras). The cameras 410 may capture color images, grayscale images, and/or other 4D images. The localization systems 412 may capture the localization data. The localization systems may include, without limitation, GNSS, inertial navigation system (INS), inertial measurement unit (IMU), global positioning system (GPS), altitude and heading reference system (AHRS), compass, and/or accelerometer. The other sensors 414 may be used to capture localization data, movement data, participant data, and/or other authorized and relevant sensor data.

The perception system 404 can generate perception data, which may detect, identify, classify, and/or determine position(s) of one or more objects, such as one or more participants, using the sensor data. The perception data may be used by a planning system 416 to determine one or more actions, for example in generating one or more actions for the mobile device 400, such as generating a navigation plan having at least one movement action for autonomously navigating the mobile device 400 along the movement path 116 from an origin towards a destination and/or adjusting operation of one or more of the device systems 406. The control system 418 may be used to control various operations of the mobile device 400, including, but not limited to, detecting participants, identifying participants, generating and homogenizing participant tiles, generating group interfaces, facilitating the communication session, executing the navigation plan, and/or other operations. The navigation plan may include various operational instructions for the subsystems 420 of the mobile device 400 to autonomously execute to perform the navigation action(s), as well as other action(s) based on content, such that the mobile device 400 moves on its own planning and decisions. Instructions for operating the mobile device 400 in view of the movement path 116 may be executed by the planning system 416, the control system 418, the subsystems 420, and/or other components of the mobile device 400. The instructions may be modified prior to execution by the mobile device 400 (e.g., using the interface system 422), and in some cases, the mobile device 400 may disregard the instructions, for example, based on the sensor data captured by the sensor system 402.

In some implementations, the interface system 422 includes a presentation system and an input system. The interface system 422 may form part of a computing device, such as a smartphone, mobile device (e.g., the mobile device 400), a robot, a wearable, a home system, and/or the like. The input system of the interface system 422 may include one or more input devices configured to capture various forms of user input. For example, the interface system 422 may be configured to capture content from various sources and/or user input from a user. Similarly, the presentation system of the interface system 422 may include one or more output devices configured to present content in various forms, including visual, audio, and/or tactile content in two-dimensions and/or three-dimensions. The interface system 422 may include various software and/or hardware for input and presentation. The input system and the presentation system may be integrated into one system, in whole or part, or separate. For example, the input system and the presentation system of the interface system 422 may be provided in the form of a touchscreen.

In some implementations, the interface system 422 provides an interactive interface. The interactive interface may be deployed in the mobile device 400. For example, the interactive interface may be deployed in an interior of the mobile device 400. The communication system 424 may include, without limitation, one or more antennae, receivers, transponders, transceivers, and/or communication ports for providing the communication session. In some cases, the communication system 424 is configured to communicate via different types of wireless networks in connection with the travel group communication session and communicating with other devices. In some examples, the communication system 424 is configured for long-range communication (e.g., via cellular network, satellite network, radio, etc.), short-range communication (e.g., Bluetooth, Wi-Fi, UWB, etc.), and/or to otherwise communicate with other devices and data sources in connection with a communication session.

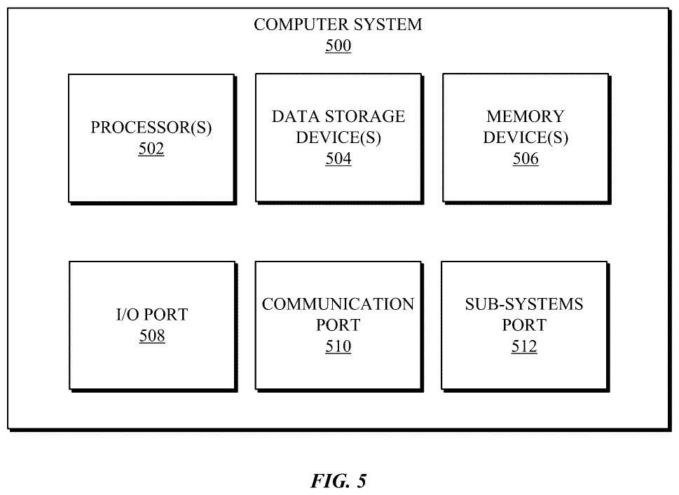

Referring to FIG. 5, a detailed description of an example computing device 500 having one or more computing units that may implement various systems and methods discussed herein is provided. Various components of the computing device 500 can be formed into a specific, non-conventional, and non-generic arrangement to achieve the various technological solutions discussed herein. As such, the computing device 500 and/or components of the computing device 500 may be applicable to the structure 114, various systems and subsystems of the mobile device 400, the various communication and interface systems described herein, and other computing or network devices. In some examples, the structure 114 and/or the mobile device 400 are vehicles, but it will be appreciated that these devices may be various types of devices, such as robots, user devices, electronic devices, home devices, and so forth. It will be appreciated that specific implementations of these devices may be of differing possible specific computing architectures not all of which are specifically discussed herein but will be understood by those of ordinary skill in the art.

The computing device 500 may be a computing system capable of executing a computer program product to execute a computer process. Data and program files may be input to the computing device 500, which reads the files and executes the programs therein. Some of the elements of the computing device 500 are shown in FIG. 5, including one or more hardware processor(s) 502, one or more data storage device(s) 504, one or more memory device(s) 506, and/or one or more port(s) 508-512. Additionally, other elements that will be recognized by those skilled in the art may be included in the computing device 500 but are not explicitly depicted in FIG. 5 or discussed further herein. Various elements of the computing device 500 may communicate with one another by way of one or more communication buses, point-to-point communication paths, or other communication means not explicitly depicted in FIG. 5.

The processor 502 may include, for example, a central processing unit (CPU), a microprocessor, a microcontroller, a digital signal processor (DSP), and/or one or more internal levels of cache. There may be one or more processors 502, such that the processor 502 comprises a single central-processing unit, or a plurality of processing units capable of executing instructions and performing operations in parallel with each other, commonly referred to as a parallel processing environment.

The computing device 500 may be a conventional computer, a distributed computer, or any other type of computer, such as one or more external computers made available via a cloud computing architecture. The presently described technology is optionally implemented in software stored on the data stored device(s) 504, stored on the memory device(s) 506, and/or communicated via one or more of the ports 508-512, thereby transforming the computing device 500 in FIG. 5 to a special purpose machine for implementing the operations described herein. Examples of the computing device 500 include personal computers, servers, purpose-built autonomy processors, terminals, workstations, mobile phones, tablets, laptops, so forth.

The one or more data storage devices 504 may include any non-volatile data storage device capable of storing data generated or employed within the computing device 500, such as computer executable instructions for performing a computer process, which may include instructions of both application programs and an operating system (OS) that manages the various components of the computing device 500. The data storage devices 504 may include, without limitation, magnetic disk drives, optical disk drives, solid state drives (SSDs), flash drives, so forth. The data storage devices 504 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and so forth. Examples of non-removable data storage media include internal magnetic hard disks, SSDs, and so forth. The one or more memory devices 506 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 504 and/or the memory devices 506, which may be referred to as machine-readable media. It will be appreciated that machine-readable media may include any tangible non-transitory medium capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 500 includes one or more port(s), such as an input/output (I/O) port(s) 508, communication port(s) 510, and sub-systems port(s) 512, for communicating with other computing, network, or vehicle devices. It will be appreciated that the ports 508-512 may be combined or separate and that more or fewer ports may be included in the computing device 500.

The I/O port 508 may be connected to an I/O device, or other device, by which information is input to or output from the computing device 500. Such I/O devices may include, without limitation, one or more input devices, output devices, and/or environment transducer devices.

In one implementation, the input devices convert a human-generated signal, such as, human voice, physical movement, physical touch or pressure, so forth, into electrical signals as input data into the computing device 500 via the I/O port 508. Similarly, the output devices may convert electrical signals received from computing device 500 via the I/O port 508 into signals that may be sensed as output by a human, such as sound, light, and/or touch. The input device may be an alphanumeric input device, including alphanumeric and other keys for communicating information and/or command selections to the processor 502 via the I/O port 508. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, so forth. In some implementations, the input device and the output device may be the same device, for example, in the case of a touchscreen.

The environment transducer devices convert one form of energy or signal into another for input into or output from the computing device 500 via the I/O port 508. For example, an electrical signal generated within the computing device 500 may be converted to another type of signal, and/or vice-versa. In one implementation, the environment transducer devices sense characteristics or aspects of an environment local to or remote from the computing device 500. Further, the environment transducer devices may generate signals to impose some effect on the environment either local to or remote from the example computing device 500.

In one implementation, a communication port 510 is connected to a network by way of which the computing device 500 may receive network data useful in executing the methods and systems set out herein as well as transmitting information and network configuration changes determined thereby. Stated differently, the communication port 510 connects the computing device 500 to one or more communication interface devices configured to transmit and/or receive information between the computing device 500 and other devices by way of one or more wired or wireless communication networks or connections. Examples of such networks or connections include, without limitation, Universal Serial Bus (USB), Ethernet, Wi-Fi, Bluetooth, Near Field Communication (NFC), cellular, and so on. One or more such communication interface devices may be utilized via the communication port 510 to communicate one or more other machines, either directly over a point-to-point communication path, over a wide area network (WAN) (e.g., the Internet), over a local area network (LAN), over a cellular (e.g., third generation (3G), fourth generation (4G) network, or fifth generation (5G)), network, or over another communication means. Further, the communication port 510 may communicate with an antenna for electromagnetic signal transmission and/or reception. In some examples, an antenna may be employed to receive Global Positioning System (GPS) data to facilitate determination of a location of a device.

The mobile devices discussed herein may include a vehicle. The computing device 500 may include a sub-systems port 512 for communicating with one or more systems to control an operation of the vehicle and/or exchange information between the computing device 500 and one or more sub-systems of the vehicle. Examples of such sub-systems, include, without limitation, imaging systems, radar, LIDAR, motor controllers and systems, battery control, fuel cell or other energy storage systems or controls in the case of such vehicles with hybrid or electric motor systems, processors and controllers, steering systems, brake systems, light systems, navigation systems, environment controls, entertainment systems, and so forth.

The present disclosure recognizes that participation in communication sessions and operations based on participant feature extraction may be used to the benefit of users. Entities implementing the present technologies should comply with established privacy policies and/or practices that meet or exceed industry or governmental requirements for maintaining the privacy and security of data being communicated. The present disclosure contemplates that any devices participating in the communication sessions and participant feature extraction would provide input interfaces for specifying when, where, and what types of communications, extractions, and operations are to occur, thereby permitting users to customize their intended functionality. Devices participating in these services may also provide indications that a communication session is requested and/or active. Moreover, users should be allowed to opt-in or opt-out of allowing a device to participate in such services, including by switching off camera(s) and muting microphone(s). In addition, particular information that is being communicated, such as messages and recipients, can be encrypted, structured, and/or coded to further maintain privacy and security. Third parties can evaluate these implementers to certify their adherence to established privacy policies and practices.

The system set forth in FIG. 5 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented. The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer).

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method comprising:
detecting a plurality of participants of a communication session, the plurality of participants collocated in an area;
obtaining participant features of each of the plurality of participants captured using at least one image sensor;
generating a plurality of participant tiles, each of the participant tiles corresponding to the participant features of a corresponding one of the plurality of participants;
generating a group interface for the communication session based on the plurality of tiles, the group interface including the participant features of each of the plurality of participants; and
rendering the group interface for display using at least one display.

2. The method of claim 1, wherein the group interface removes background content from the area.

3. The method of claim 1, wherein the at least one image sensor includes a plurality of image sensors having overlapping fields of view of the area.

4. The method of claim 1, further comprising:
obtaining second participant features of each of one or more second participants located in a second area, the second area being outside of one or more fields of view of the at least one image sensor; and
generating one or more second participant tiles, the group interface for the communication session being further generated based on the one or more second participant tiles.

5. The method of claim 1, wherein the area is an interior of a structure.

6. The method of claim 1, further comprising:
detecting an operation mode transition trigger using the participant features; and
transitioning an electronic device between a first operation mode and a second operation mode based on the operation mode transition trigger.

7. The method of claim 5, wherein the group interface includes the participant features of each of the plurality of participants arranged according to a corresponding position of each of the plurality of participants within the interior of the structure.

8. The method of claim 1, further comprising:
homogenizing the plurality of participant tiles.

9. The method of claim 8, wherein homogenizing the plurality of participant tiles comprises:
applying a tile optimization action to at least one participant tile of the plurality of participant tiles, the tile optimization action modifying the at least one participant tile within two-dimensions.

10. The method of claim 8, wherein homogenizing the plurality of participant tiles comprises:
applying a feature optimization action to the participant features of at least one participant tile of the plurality of participant tiles, the feature optimization action modifying the participant features within three-dimensions.

11. The method of claim 10, wherein modifying the participant features within three-dimensions comprises:
modifying a viewing angle of one or more of the plurality of participants.

12. The method of claim 1, further comprising:
detecting an occlusion of a portion of the participant features of a specific participant of the plurality of participants; and
generating an unobstructed view of the specific participant using a heuristics action, the unobstructed view including a rendering of the portion of the participant features.

13. The method of claim 12, further comprising:
determining an expression of the specific participant; and
matching the rendering of the portion of the participant features with the expression of the specific participant.

14. One or more tangible non-transitory computer-readable storage media storing computer-executable instructions for performing a computer process on a computing system, the computer process comprising:
detecting a plurality of participants of a communication session, the plurality of participants collocated in an area;
extracting participant features of each of the plurality of participants from image data of the area;
generating a plurality of participant tiles, each of the participant tiles corresponding to the participant features of a corresponding one of the plurality of participants;
generating a group interface for the communication session based on the plurality of tiles, the group interface including the participant features of each of the plurality of participants; and
outputting the group interface for display during the communication session.

15. The one or more tangible non-transitory computer-readable storage media of claim 14, wherein the image data includes video.

16. The one or more tangible non-transitory computer-readable storage media of claim 14, wherein the group interface omits background content from the area.

17. The one or more tangible non-transitory computer-readable storage media of claim 14, further comprising:
determining an expression of a specific participant of the plurality of participants; and
generating a rendering of a portion of the participant features corresponding to the specific participant, the rendering generated based on the expression.

18. A system comprising:
at least one image sensor configured to capture image data of a plurality of participants of a communication session collocated in an area;
at least one processor configured to generate a group interface for the communication session based on a plurality of participant tiles, each of the participant tiles generated based on the image data and corresponding to participant features of a corresponding one of the plurality of participants, the group interface including the participant features of each of the plurality of participants; and
a display displaying the group interface during the communication session.

19. The system of claim 18, wherein the at least one image sensor includes a depth sensor and the image data includes depth data of the participant features, the participant features being rendered in three-dimensions in the group interface based on the depth data.

20. The system of claim 18, wherein the at least one processor is configured to homogenize the plurality of participant tiles.
